(19) United States
(12) Patent Application Publication
(10) Pub. No.: US 2014/0250134 A1
(43) Pub. Date: Sep. 4, 2014

(54) METHOD AND SYSTEM OF TARGETING QUERIES BASED ON LOCATION

(71) Applicant: ChaCha Search, Inc, Carmel, IN (US)

(72) Inventor: Scott A. Jones, Carmel, IN (US)

(73) Assignee: ChaCha Search, Inc, Carmel, IN (US)

(21) Appl. No.: 14/195,902

(22) Filed: Mar. 4, 2014

Related U.S. Application Data
(60) Provisional application No. 61/772,388, filed on Mar. 4, 2013.

(51) Int. Cl. G06F 17/30

(52) U.S. Cl. CPC G06F 17/3053; G06F 17/30241
USPC 707/748; 707/705

(57) ABSTRACT

A system and method for management of location based requests is described. A responder for a request may be selected based on a location associated with a request and a ranking or rating of a responder for a location. A location may be associated with a responder based on requests accepted by the responder, submitted by the responder, and/or otherwise associated with a location and a responder.

### BACKGROUND

1. Field of the Invention

The present invention is related to use of targeted, location-based queries and human assisted search.

2. Description of the Related Art

In systems wherein a peer-to-peer response system is employed, it is difficult to properly target a request for information. Current systems such as the FourSquare® service allow a user to check-in at a location which may then be shared by social medial such as the Facebook® or Twitter® blogging services. Such systems may make recommendations to a user based on information of users who have checked-in, or merchants who have provided information of promotions or offers.

However, such systems have limited utility as the notifications to a user of activities at various locations are based on information which is pushed to the user rather than requested by the user. Users might have interest in a particular restaurant, but might want to know some particular information regarding the menu, dress code, or current waiting time for a table. Unless such information is provided, it is not accessible to the user.

Services such as LocalMind permit a user to direct a question to experts based on a business in which the expert's location is detected. However, LocalMind is constrained to association of users with businesses in order to direct a query.

Because of these and other problems, a method and system of targeting queries based on location would be greatly appreciated

### SUMMARY

A system is provided for directing a request to one or more persons who may respond to the request. A user device receives a query from a user and transmits the query to a server. The user device provides an interface which allows the user to direct a query to persons who may respond to the query. The user device may allow a user to select a location, and may provide information of target recipients of the query who are associated with the location. The server may provide information used to render the interface to a user device. For example, a user may be provided with a map and/or search functionality which would allow the user to identify a location based on visual information of the map and/or a text-based search for a business name, category, or keyword. The server may comprise a database which includes information of persons willing to respond to requests or “answerers”. Answerers may be any person who has registered to respond to requests, and may be users who have submitted requests. An answerer may be associated with information which may be used to improve targeting of a query or request. For example, information such as interests, keywords, demographics, etc. of an answerer may be available to a server device.

A server device is provided which receives a query from a user and directs the query to a number of answerer devices. An answerer device may receive a query, and may provide a response to the query. An answerer device may provide information of an answerer to the server device. For example, location information associated with an answerer may be used to determine whether an answerer device is located in a target area. An answerer device may provide presence information which may be used to determine whether an answerer is currently accepting requests, is accepting notifications, has previously responded to requests, has submitted a request, is waiting for a response, etc.

If a user decides to submit a request based on a location, the user device may present a visual interface for targeting a request to the location. A user may be presented with an indicator of a number of answerers available within a selected target area. For example, if a user wishes to direct a request to persons located in place of business, or a park, or another well-defined area, the user may be provided with numeric and/or graphical indicators of answerers within that location. In the instance where a location is not well defined, as user may target a query using a geometric shape such as a circle, square, etc. which may be scaled to meet the user's desired location target. Similarly, altitude might be used to determine a location in instances where a population of answerers might be identified according to a floor of a building, etc. Answerers might be anonymous, but might be identified if the answerer has consented to be identified to a user submitting the request.

Answerers may be selected based on a type assigned to a request. Temporal sensitivity, information type sought such as subjective or objective, demographics, subject matter, etc. may affect a ranking of a responder for a request. If a request is seeking temporal information responders currently associated with a location may have a higher ranking for a request and thus be more likely to receive a request. Similarly, if a request is seeking subjective information, a larger group of responders might be selected than if a request is seeking objective information. If a stored response matches a request a human assistant may determine whether the stored response is acceptable. An action of a human assistant may cause a request to be delivered to a responder if the action indicates that a request is temporally sensitive. An answerer may be selected based on a bid of the answerer associated with a location and a subject matter of a request.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for request records.

FIG. 3 illustrates a database for user records.

FIG. 4 illustrates a database for answerer records.

FIG. 5 illustrates a database for entity records.

FIG. 6 is a flowchart of providing an answer.

FIG. 7 is a Graphical User Interface (GUI) for submitting a request.

FIG. 8 is a GUI for processing a request by an answerer.

FIG. 9 is a GUI for processing a request by a different answerer.

FIG. 10 is a GUI for receiving a response to a request.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server or answer device receiving the query, a database storing information of queries, search results, answerers, users, resources and other information, a guide system or answerer system receiving a query and providing a search result.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing a query may include a human answerer who responds to the query or “answerer” or “responder”. An answerer may receive a query, information of a source of the query, and/or the location of the user. An answerer may formulate a response based on a query, and submit the response for delivery to a user responsive to the query. In at least one embodiment, an answerer may receive location parameters provided implicitly and/or explicitly by the user upon which selection of the answer may depend.

An answerer may be characterized according to various parameters. An answerer may be evaluated based on a number of responses obtained from and/or using the resource. An answerer may be evaluated based on a number of times that an answer obtained from the answerer is reused. An answerer may be evaluated based on an affiliate relationship between a provider of a resource and a provider of search services. An answerer may be evaluated based on the answerer's location at the time the query is submitted. An answerer may be evaluated based on the answerer's history of responses to search requests with similar location parameters. An answerer may be evaluated based on a type of information requested. For example, if a request is seeking factual information a different selection process may be applied for an answerer than if a request is seeking subjective or opinion information. An answerer and/or a response may be selected based on a bid of a responder associated with a location.

As used herein, a “request” means a request for information, products, and/or services. A request or search request or query may include various types of media, and may be provided by any user system which may establish communication with a server and/or other devices associated with a search service. A request may be referred to as a “search request”, “search query”, “query” or “question”.

A “user” is a person who submits a request and may receive any type of information responsive to a request. A user may be any person or entity.

An “answerer” is a person who may respond to a query. An answerer may respond based on the answerer's personal knowledge of the query's subject matter, the location implicitly and/or explicitly submitted by the user, a search by an answerer, a selection of an answerer, etc. An answerer may be a user, a human assistant selected for a task, a person affiliated with an entity such as a business, organization, etc. An answerer may be referred to as a responder. An answerer may be referred to as a searcher or guide. A guide or searcher may be compensated based on a response.

A “result”, “response”, “answer”, “response” or “search result” is any information which has been determined to be a response to a request. A result may be any information which is provided as a response to a request. A response may include a sponsored answer and/or advertisement.

A “resource” or “search resource” may be any source of information which may provide a search result and/or other information. A resource may include a search engine, a web server, a software application, an API, printed media, an RSS feed, streaming media, a web page, a database, etc. A resource may include a person who may provide information.

A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a responder and/or a search system may include conversion of text to speech and speech to text. Any type of media which can be sent and/or received using a communication system may be part of a communication session. A communication session may be conducted using any or all communication services associated with a user, a responder, and/or a search system. Any communication session may include communication via multiple services and/or devices. For example, a request may be submitted as a voice query, which might indicate an image located on a resource accessible to a user. A voice query might be converted to a text message, an image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, a responder, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide or responder using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

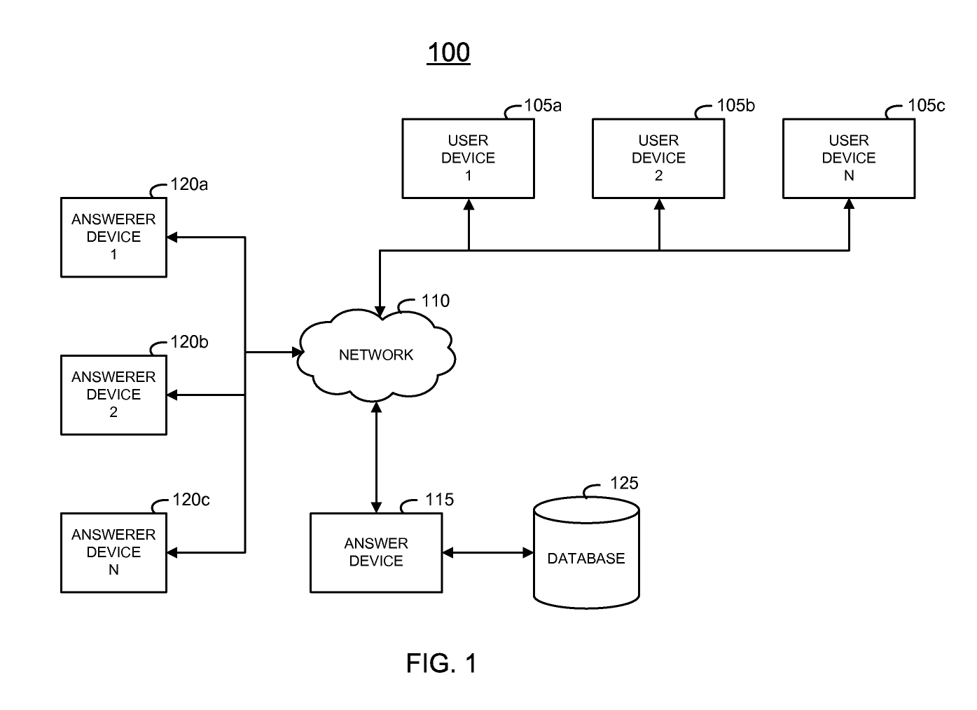

As illustrated in FIG. 1, system 100 includes user devices 105a-105c, a network 110 such as the Internet, an answer device 115, answerer devices 120a-120c, and a database 125, which may comprise various records. Answerer systems may be operated by users, paid searchers or “guides”, volunteer responders, an entity such as business or organization, etc.

While only a few systems associated with a user and a responder are depicted in FIG. 1 it is within the scope of the disclosure for multiple systems for a user, answerer, and guide to be utilized. In particular, it is envisioned that many user, answer device, and answerer systems may be implemented. The answer device 115 may be composed of any number of components as described further herein.

Any user system (e.g. the user device 105a) can be used to submit a request to the answer device 115 and/or receive a result and/or other information. Any user device may receive a response, and/or may provide compensation to the answer device 115.

The network 110 may be a global public network of networks (i.e., the Internet) and/or may consist in whole or in part of one or more private networks and communicatively couples the user devices 105a-105c, the answer device 115, the answer devices 120a-120c and the database 125. The network 110 may include one or more wireless networks which may enable wireless communication between the various elements of the system 100. For example, the answer device 115 may receive messages which may be routed via a wireless network controlled by a wireless service to the user device 105b. A wireless service may receive messages from the answer device 115, answerer devices 120a-120c, and database 125 via a wireless network which is a part of the network 110, and provide the messages to the user device 105c via an internet connection which is part of the network 110. Similarly a voice communication via wired and/or wireless communication might be established between any elements of the system 100.

The answer device 115 allows interaction to occur among the user devices 105a-105c the answerer devices 120a-120c and the database 125. For example, a response can be transmitted from the answerer device 120a, which may provide information obtained from the database 125, to the user device 105b.

Similarly, an answer from the answerer device 120a might be routed to the answer device 115, which might process the result, formulate a response and provide a message to the user device 105c. Any type of communication between users, resources, and/or answerers may be mediated and/or facilitated by the answerer device 115, and/or other elements of the system 100.

The answer device 115 is communicatively coupled with the database 125. As will be described herein in further detail below, database 125 includes data that is processed in association with operation of the embodiments. Although FIG. 1 illustrates the database 125 as a separate component of the system 100, the database 125 may be integrated with the answer device 115. Further, records maintained in the database 125 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. An operating system such as the Windows® or Linux operating systems may be operative on the database 125. Elements of the database 125 may reside in any suitable elements of the system 100. Any or all elements of the system 100 may include any or the entirety of the database 125.

The user devices 105a-105c, the answer device 115, the answerer devices 120a-120c, and the database 125 may include equipment, software, systems and personnel required to send and/or receive messages between a user device, the answer device 115, an answerer device, and/or the database 125. The network 110 may include hardware and/or software components which may allow the answer device 115 to establish communication between any or all of the elements of the system 100.

A user device such as the user device 105a may be a desktop, portable, or tablet PC or Mac®, a mobile phone, a smart phone, a PDA, a server system, a landline phone, a specialized communication terminal, a terminal connected to a mainframe, or any other communication hardware and/or system. The answer device 115 may include one or more servers, computers, etc. For example, servers such as the PowerEdge® 2900 by Dell, or the BladeCenterJS22 by IBM, or equivalent systems might be used to implement elements of the answer device 115. The answer device 115 may utilize an operating system (OS) such as Microsoft Windows XP®, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, responder systems and/or to implement the answer device 115.

A user may be identified by the answer device 115. When a user device, such as the user device 105b, establishes a communication session with the answer device 115, an identifier of a user device is determined. An identifier of a user device or user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user device 105c and a resource, an answerer system, and/or the answer device 115. Information such as a keyword, a category, a user profile, a request, a result, etc., may be associated with a user. Parameters and/or attributes may be associated with a user as an answerer as will be further described herein below. Information of a user may be stored in the database 125.

An answerer may be required to register with the answer device 115. As part of a registration process, at least one communication method is associated with an answerer. In at least one embodiment, an answerer may register with the answer device 115 and establish a username and password which are associated with the answerer. A guide or responder or answerer may login to the answer device 115 using a web browser functionality of the answerer device 120c in order to communicate with the answer device 115. Multiple communication services may be associated with an answerer and may allow a communication session to be established between an answerer and the answer device 115. A responder may register using an application resident on the answerer device 120c. Multiple identifiers of an answerer may be associated with each other. Information such as IM credentials, email addresses, phone numbers, URLs, and a username, etc., of an answerer may be identified which may allow the answer device 115 to establish communication between an answerer system, a user system, a resource and/or the answer device 115.

When an answerer registers with the answer device 115, the answerer may be associated with one or more keywords, categories, profiles, locations, and/or other information. Information associated with an answerer may be stored in the database 125 and may be used for various purposes. Information associated with an answerer may be used to rank requests, resources, results, advertisements, sponsors and/or other information which may be presented to an answerer. In at least one embodiment, an answerer may be required to undergo testing to determine whether an answerer or responder is able to perform any tasks which may be required by the answer device 115. For example, an answerer may be assigned to a role such as translator, transcriber, expediter, generalist, specialist, auditor, etc.

An entity may register with the answer device 115. As part of a registration process, at least one communication method is associated with a business or entity. In at least one embodiment, a business may register with the answer device 115 and establish a username and password which are associated with the business. A business may login to the answer device 115. Multiple identifiers of a business may be associated with each other. For example, a plurality of devices associated with an entity may be designated as answerer devices for an entity. Information such as IM credentials, an email address, a phone number, a URL, a username, etc., of a business may be identified that may allow the answer device 115 to establish a communication session between a user device, an entity, an answerer system, and/or the answer device 115.

When an entity registers with the answer device 115, the entity may be associated with one or more keywords, categories, profiles, locations and/or other information. Information associated with a business or entity may be stored in database 125 and may be used for various purposes. Information associated with a business may be used to rank requests, resources, results, advertisements, guides and/or other information which may be presented to the business. In at least one embodiment, payment information is associated with a business. A business may provide payment information which may be used to compensate a provider of the answer device 115 for advertisements and/or sponsored answers provided to a user. A business may designate a guide associated with an answerer, and may provide registration information associated with the sponsored answerer. A business may provide information associated with a resource. A business may designate conditions for accessing a resource provided to an answerer. An entity may provide different access rights to a resource for answerers designated by the business than for answerers not associated with an entity. Any entity may be an answerer and may be associated with an answerer device such as the answerer device 120b. An answerer device such as the answerer device 120c may provide an automated response, may provide information to answerers, etc.

Records may be maintained in the database 125 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

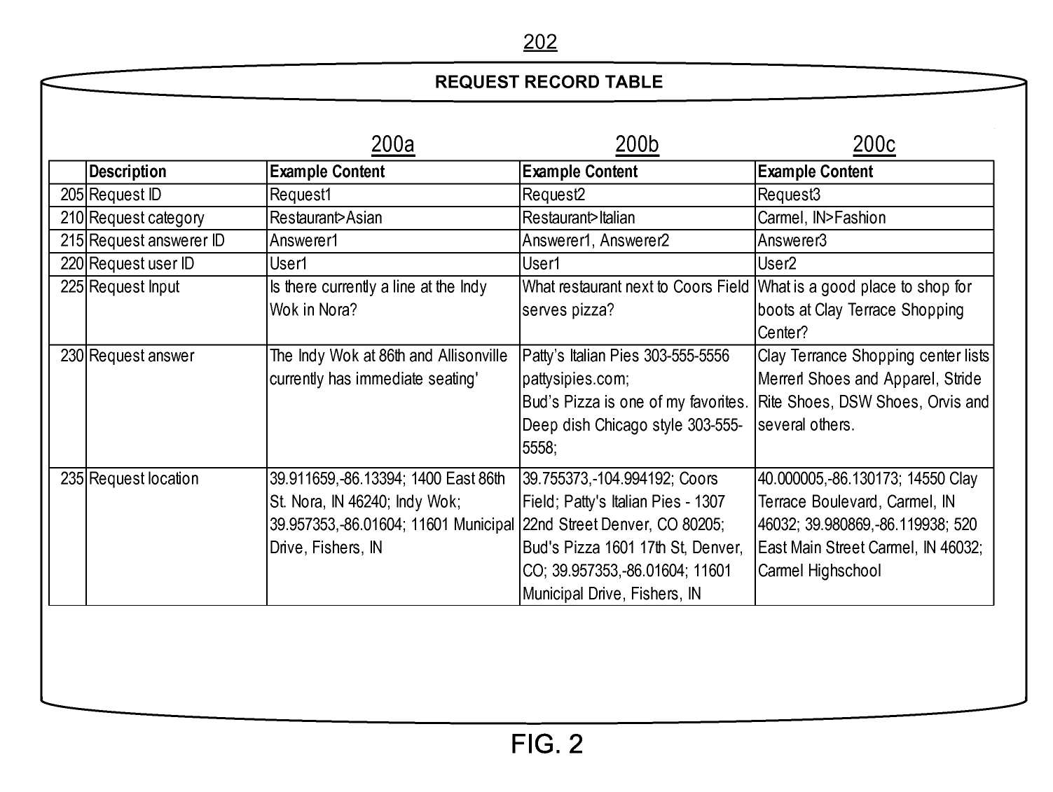

As illustrated in FIG. 2, an exemplary request record table 202 is provided. The request record table 202 may comprise a number of request records of which one or more may be associated with or resident in the database 125 (FIG. 1). The request record table 202 may include information of requests which may be processed. The request records 200 may include a request ID field 205, a request category field 210, a request answerer ID field 215, a request user ID field 220, a request input field 225, a request answer field 230, and a request location field 235.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category associated with a request may be used to rank answerers who may be associated with the type of request. Likewise, a category associated with a request may be used to rank requests and/or responses which may be presented to a person such as a guide or paid searcher, responder, answerer, etc. A category associated with a request may be determined based on factors such as keywords of a query, a profile of a user, a user history, etc. A category associated with a system taxonomy may be indicated in the request category field 210. A category may be associated with a request automatically and/or using the assistance of a person. Using the example in Fig. example in FIG. 2, ‘Request2’ may be categorized as ‘Restaurant>Italian’ as indicated in the request record 200b. This may indicate that a person or item associated with the category ‘Restaurant>Italian’ may have a higher ranking for responding to ‘Request2’. A category of a request may be associated with a user submitting the request. Content of a request such as a keyword, named entity, etc. may be used to assign a category or type to a request. For example, a request may be associated with the type ‘Local’ based on a named entity, an action by a user, an action by an answerer, an action by a guide, etc. For example, a user may submit a request via an app which indicates that a request is location sensitive, may select a control to indicate a question is location sensitive, etc.

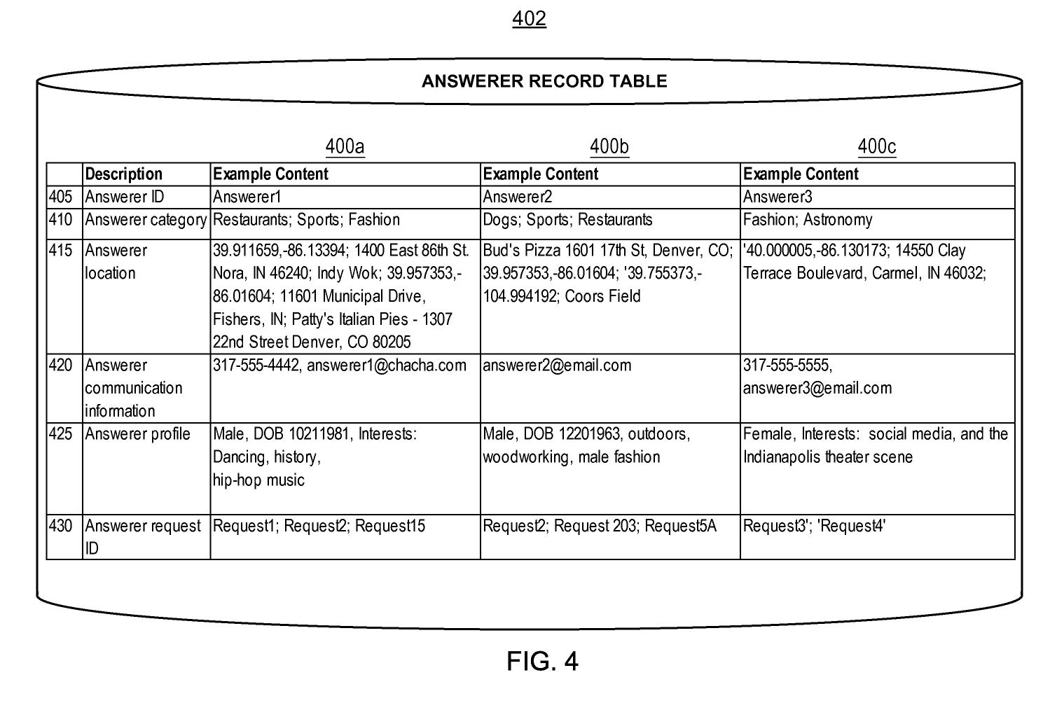

The request answerer ID field 215 may include information of a number of answerers associated with a request. Content of the request answerer ID field 215 may be used to obtain information of an answerer using a record such as that depicted in FIG. 4. If a person is selected for a request, elects to receive a request, provides a response to a request, reviews a result of a request and/or completes a request, an identifier of the person may be indicated in the request answerer ID field 215.

The request user ID field 220 may include information of a number of users associated with a request. Content of the request user ID field 220 may be used to obtain information of a user associated with a request. For example, if a request is submitted by a user, an identifier of the user may be indicated in the request user ID field 220. Using the example in FIG. 2, ‘User1’ is associated with ‘Request1’ and ‘Request2’ and ‘User2’ is associated with ‘Request3’. This may indicate that ‘Request1’ and ‘Request2’ were submitted by ‘User1’ while ‘Request3’ was submitted by ‘User2’.

The request input field 225 may include information of a request. Content of the request input field 225 may be provided to a person who accepts a request. Content of the request input field 225 may include any type of information. For example, a pointer to audio, video, text, and/or other media may be indicated in the request input field 225. As illustrated in FIG. 2, the query ‘What is a good place to shop for boots at Clay Terrace Shopping Center?’ is the request input associated with ‘Request3’, as indicated in the request record 200c. In at least one embodiment, the request input field 225 may indicate an original user request, a categorization, and a rewritten user request.

The request answer field 230 may include information of a response associated with a request. Content of the request answer field 230 may be reviewed and/or rated by a user, a guide, a responder, and/or an administrator. As illustrated in FIG. 2, the response “Clay Terrance Shopping center lists Merrel Shoes and Apparel, Stride Rite Shoes, DSW Shoes, Orvis and several others.” is associated with ‘Request3’ as illustrated in the request record 200c. While a text response to a query is used for the purposes of illustration, any type of media may be indicated in the request answer field 230. In at least one embodiment, a text response and a URL associated with a source of the text response may be indicated in the request answer field 230. The request answerer ID field 215 may be linked with the request answer field 230 by for example a pointer. As illustrated in FIG. 2, ‘Answerer1’ may be associated with the answer ‘Patty's Italian Pies 303-555-5556 <<pattysipies.com>>’ and ‘Answerer2’ may have provided the answer ‘Bud's Pizza is one of my favorites. Deep dish Chicago style 303-555-5558’ as indicated in the request record 200b.

The request location field 235 may include information of a location associated with a request. For example, latitude and longitude information supplied by a user device may be indicated in the request location field 235. A location indicated by a user may be indicated in the request location field 235. For example, if a user selects a location using a map functionality a location determined based on the map may be indicated in the request location field 235. Content of the request location field 235 may be determined based on a named entity indicated in a query and/or an answer. A responder or answerer may determine location information associated with a request. If a request location is ambiguous, a user may be required to remove any ambiguity in order that a request may be routed properly. A location associated with a request may be used to rate or rank an answerer for a request. For example, if an answerer has submitted a request associated with a location identified by a query a ranking of the answerer for responding to the request may be increased. Temporal information associated with a request may affect a ranking of a responder for a request. For example, if a responder is associated with a location indicated by a request, a ranking of the responder may be affected by an amount of time between the request and a query submitted by the responder associated with the location.

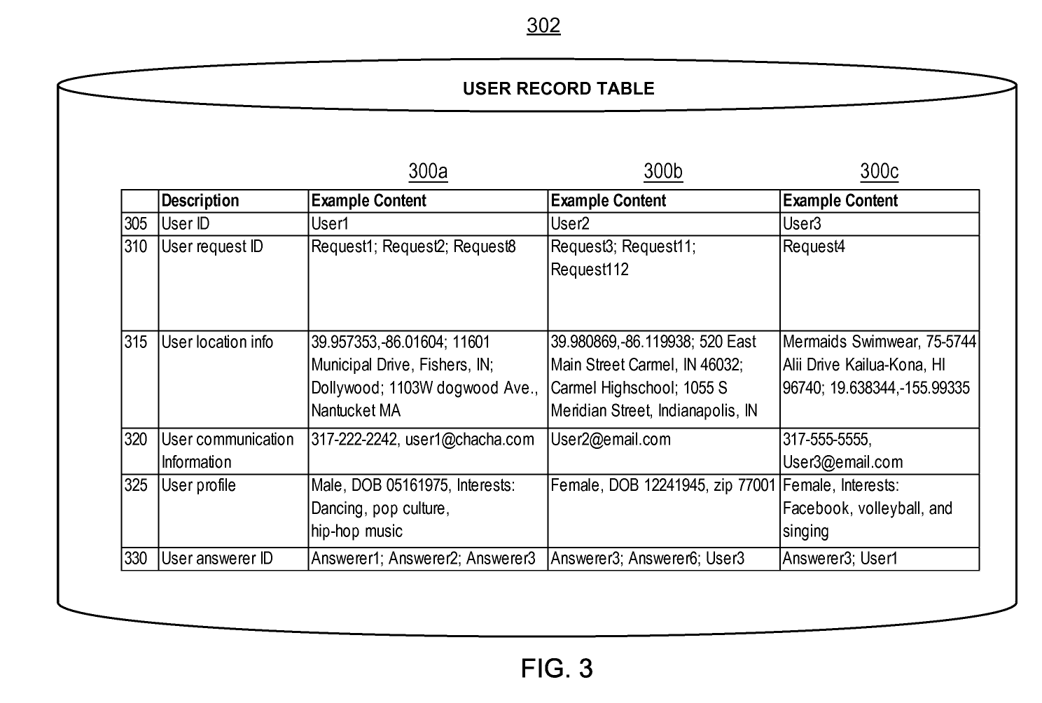

As illustrated in FIG. 3, an exemplary user record table 302 is provided. The user record table 302 may comprise a number of user records of which one or more may be associated with or resident in the database 125 (FIG. 1). The user record table 302 may include information of users. The user records 300 may include a user ID field 305, a user request ID field 310, a user location field 315, a user communication information field 320, a user profile field 325, and a user answerer ID field 330.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User3’ is the user ID associated with the user record 300c.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request3’, ‘Request11’ and ‘Request112’ are associated with ‘User2’ as indicated in the user record 300b. This may indicate that ‘User2’ has submitted ‘Request3’, ‘Request11’ and ‘Request112’.

The user location field 315 may include information of a location associated with a user. For example, if a request is directed to a type of restaurant in a given location, an indicator of a location associated with the restaurant may be indicated in the user location field 315. A location associated with an answerer may be indicated in the user location field 315. In at least one embodiment, the user request ID field 310 and the user location field 315 are linked by, for example, a pointer. As illustrated in FIG. 3, the location ‘39.957353, −86.01604; 11601 Municipal Drive, Fishers, IN’ associated with ‘Request1’ and ‘Request2’ is associated with ‘User1’ as indicated in the user record 300a. In at least one embodiment, a location associated with a request of a user may affect which answerers are notified of a request. A location of a user may affect a category associated with a request of a user. If a user has elected to respond to requests, a user may be selected as an answerer based on a location associated with a user. A ranking of a user may be based on a location associated with the user and temporal data associated with a location and a user. A time stamp associated with a request may be associated with a user and a location. For example, if a responder or answerer frequently submits queries associated with a location a responder may have a higher ranking associated with a location than an answerer currently in the location.

The user communication information field 320 may include information of a number of communication services associated with a user. Any information which may be used to establish communication with a user may be indicated in the user communication information field 320. For example, a telephone number, an email address, an IM credential, a URL, a username, a password, and/or other communication information may be indicated in the user communication information field 320. Using the example in FIG. 3, the phone number ‘317.222.2242’ and the email ‘user1@chacha.com’ are associated with ‘User1’. A type of communication service associated with a user and a request may affect a ranking of a user for a location associated with a request.

The user profile field 325 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. A ranking of an answerer might be modified based on geographic, demographic, etc. profile information of a user.

The user answerer ID field 330 may include information of answerers selected for a user request. Content of the user answerer ID field 330 may be used to determine answerers associated with locations and subject matter identified with a user. Content of the user answerer ID field 330 may be used to obtain information of an answerer. For example, if a user request requires a response based in part on location, the answer device 115 (FIG. 1) may rank an answerer based on a previous response to a request of a user. If an answerer has responded to a previous request of a user, the answerer may have a higher ranking for a request of a user. If a responder has responded to requests submitted by a user with a profile matching a user, the responder may have a higher ranking for a request associated with a user with a similar profile. An answerer associated with a user may be ranked higher and/or may be more likely to be selected to respond to requests by users with a similar profile, location, etc. A number of answers by a responder associated with a user may affect a probability or ranking of a responder for a query. For example, if a responder has responded to a higher number of requests associated with a user the responder may be more likely or probable to be selected to respond to a request from the user.

As illustrated in FIG. 4 an exemplary answerer record table 402 is provided. The answerer record table 402 may comprise a number of answerer records of which one or more may be associated with or resident in the database 125 (FIG. 1). Answerer records 400 may include an answerer ID field 405, an answerer category field 410, an answerer location field 415, an answerer communication information field 420, an answerer profile field 425, and an answerer request ID field 430.

The answerer ID field 405 includes an identifier of an answerer which is preferably unique and used consistently. Any number of characters, numbers, and/or other indicators may be used to indicate an answerer ID. In at least one embodiment, a pseudonym selected by an answerer may be indicated in the answerer ID field 405. Using the example in FIG. 4, ‘Answerer1’ is the answerer ID associated with the answerer record 400a.

The answerer category field 410 may include information of a category associated with an answerer. Information indicated in the answerer category field 410 may be used to select an answerer for a question. For example, a category associated with a question may be used to identify answerers who may be associated with that class of request. A category associated with an answerer may be determined based on factors such as keywords of a query, an answer, a profile of an answerer, an answerer history, etc. A category may be associated with an answerer automatically and/or using the assistance of a person. Using the example in FIG. 4, ‘Sports’ is associated with ‘Answerer1’ and ‘Answerer2’ this may mean that a ranking of ‘Answerer1’ and ‘Answerer2’ might be used to determine an order in which ‘Answerer1’ and ‘Answerer2’ are notified when the answer device is responding to a request associated with the category ‘Sports’. Content of an answer such as a keyword, named entity, etc. may be used to assign a category or type to an answerer. For example, if an answerer has provided responses including keywords associated with a category an answerer might be offered an opportunity to register for the category, the keywords, and/or related subject matter.

The answerer location field 415 may include information of a location associated with an answerer. Content of the answerer location field 415 may be used to associate an answerer with a query. Content of the answerer location field 415 may be used to associate an answerer with a query based on the locations associated with an answerer's previous and/or current locations. As illustrated in FIG. 4, if a query such as ‘Request3’ as per the request record 200c (FIG. 2) is associated with the category ‘Fashion’, ‘Answerer1’ and ‘Answerer3’ might be ranked and/or rated based on a location associated the request (i.e. ‘14550 Clay Terrace Boulevard, Carmel, IN 46032’) and responses associated with the category ‘Fashion’ to determine which answerer might be more likely to respond to the request and/or notified of a request.

The answerer communication information field 420 may include information of a number of communication methods associated with the answerer. For example, an email address, an IM credential, a phone number, a web page, a physical address, etc., may be indicated in the answerer communication information field 420. As illustrated in FIG. 4, ‘Answerer3’ might be contacted at ‘317-555-5555’ and/or ‘answerer3@email.com’ as indicated by the answerer record 400c.

The answerer profile field 425 may include an answerer's demographic information, interests, areas of expertise, etc. Content of the answer profile field 425 may be stored in the database 125 (FIG. 1). A query regarding ‘woodworking’ may be more likely to be offered to ‘Answerer2’ as indicated by content of the answerer profile field 425 of the answerer record 400b.

The answerer request ID field 430 may include information of requests associated with an answerer. Content of the answerer request ID field 435 may be stored in a database 125 (FIG. 1). Using the example in FIG. 4, ‘Request3’ and ‘Request4’ are associated with ‘Answerer3’. Content of the answerer request ID field 430 may be used to associate a location with an answerer. For example, if a request indicated in the answerer request ID field 430 indicates a location the location may be associated with an answerer. Likewise, if an answerer has responded to a query associated with a location, declined to respond to a query associated with a location, provided a response referring to a location, provided a response while in a location, etc. a ranking of the answerer for the location may be adjusted.

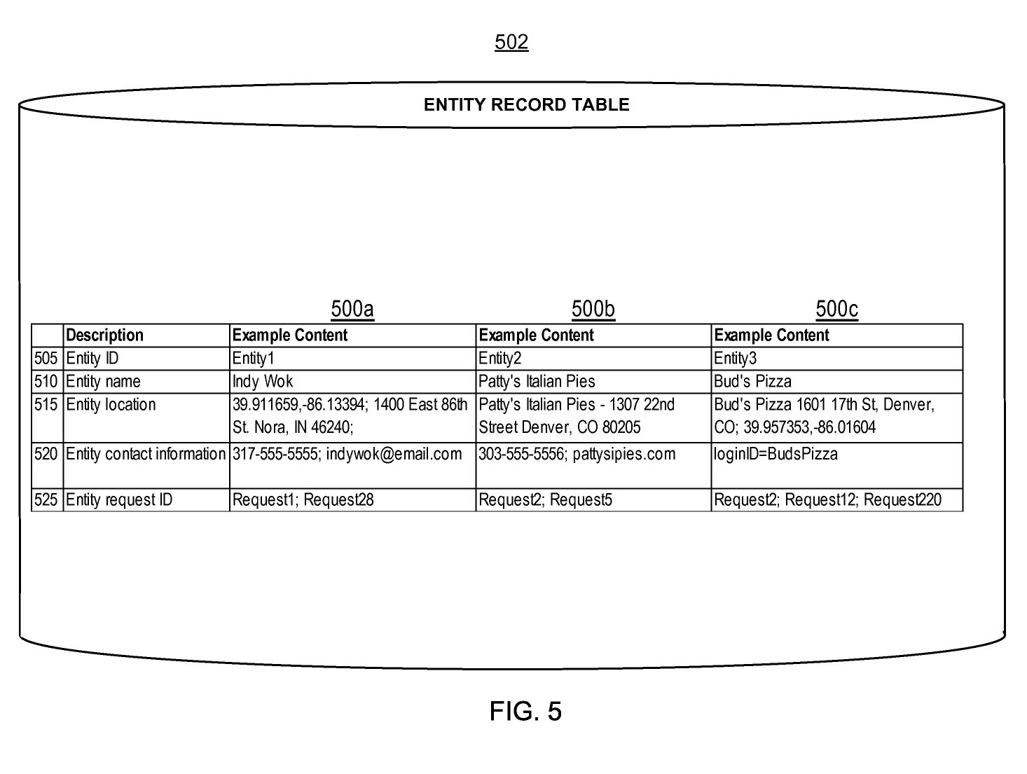

As illustrated in FIG. 5, an exemplary entity data table 502 is provided. The entity table 502 may comprise a number of entity records of which one or more may be associated with or resident in the database 125 (FIG. 1). An entity record 500 may include an entity ID field 505, an entity name field 510, an entity location field 515, an entity contact information field 520, and an entity request ID field 525.

The entity ID field 505 includes an identifier of an entity which is preferably unique and is preferably used consistently. An entity ID serves to distinguish an entity associated with a request from an entity associated with other requests. Any number of characters, numbers, and/or other indicators may be used to indicate an entity ID. In at least one embodiment, an entity ID is associated with an answer in which the entity was referenced. As illustrated in FIG. 5, ‘Entity1’ is the entity ID associated with the entity record 500a.

The entity name field 510 may include an entity name that is associated with an entity. Information indicated in the entity name field 510 may be used to select an answerer for a question. For example, if an answerer has responded to a request including content of the entity name field 510, the answerer may be associated with a location indicated in the entity location field 515. If a user recently submitted a question associated with an entity a ranking of the user as a responder for a request associated with the location may be adjusted. For example, if a user submitted a question regarding ‘Pattie's Italian Pies’, a ranking of the user as a responder for requests associated with entities close to ‘1307 22^{nd} Street Denver, Colo.’ might be increased as indicated by the entity record 500b.

The entity location field 515 may include a location that is associated with an entity ID 505. Information indicated in the entity location field 515 may be used to select an answerer for a question. As illustrated in the entity record 500c, ‘Bud's Pizza’ is located at ‘1601 17th St, Denver, Colo.’, which may be converted to GPS coordinates which are close to ‘39.957353, −86.01604’. If a responder has answered a question regarding ‘Bud's Pizza’ the answerer may be more likely to receive a request associated with coordinates in proximity to ‘39.957353, −86.01604’.

The entity contact information field 520 may include information of a number of communication services associated with an entity. For example, an email address, an IM credential, a phone number, a web page, a physical address, etc., may be indicated in the entity contact information field 520. A communication service indicated in the resource communication information field 520 may, for example, be used to indicate a service by which a resource may be accessed. Using the example illustrated in FIG. 5, the email ‘indywok@email.com’ is associated with ‘Indy Wok’. This may indicate that a query associated with the Indy Wok may be submitted to that email address. In an embodiment, an entity may designate keywords and/or be assigned keywords which may be used to direct a request to a responder. For example, if a responder has provided an answer associated with an entity, a keyword associated with the entity may be used to rank the responder for requests associated with the keyword. Information indicated in the entity contact information field 520 may be used to direct a request to a responder associated with an entity.

The entity request ID field 525 may include information of a number of requests which reference an entity. For example, an entity may have been a subject of previous queries, and answers generated may be used by the answerer device 115 (FIG. 1) and/or answerers to answer a pending query. A request indicated in the entity request ID field 525 may be used to obtain information of a user, a location, a responder, a category, a keyword, a profile, etc. associated with an entity. For example, if users associated with a profile submit queries associated with an entity an entity may be ranked higher for profile parameters shared by users associated with the queries. Likewise keywords of requests indicating an entity may be associated with an entity. An entity may provide a resource, an answer and/or a responder for queries associated with an entity.

While particular groupings, structures and linkages of information have been used for the purposes of illustration of the records herein no limitation is implied. Other equivalent data constructs and structures as would readily occur to one of ordinary skill in the relevant art may be used to implement the records and tables described herein as would be required for the operation of the embodiments disclosed herein. While a few records have been used for simplicity of explanation, it is envisioned that many records may be implemented.

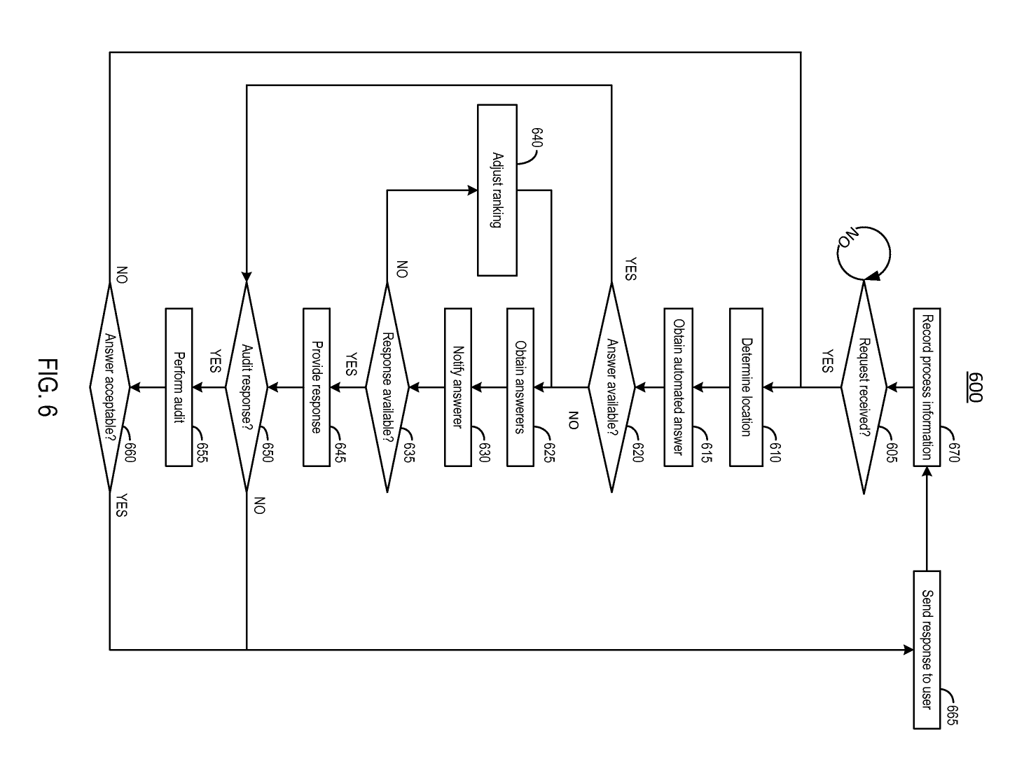

As illustrated in FIG. 6, a process 600 for providing a response is provided. The process 600 may be performed in whole or in part by any suitable element of the system 100 (FIG. 1). In at least one embodiment, the process 600 is operative on a server associated with the answer device 115.

In operation 605 (FIG. 6), a determination is made as to whether a request is received. If it is determined in operation 605 that a request is not received, control remains at operation 605 and process 600 continues. If it is determined in operation 605 that a request is received, control is passed to operation 610 and process 600 continues.

The determination in operation 605 may be made using various criteria. In at least one embodiment, if a message is received at a system associated with the answer device 115 (FIG. 1), it may be determined that a request is received. For example, if an email message, an SMS, EMS, and/or MMS message, an IM, an IP message, and/or a voice message is received at an address associated with the answer device 115 (FIG. 1), it may be determined that a request is received. If a message is received at a server associated with the answer device 115 (FIG. 1), it may be determined that a request is received.

In operation 610, a location is determined. A location may be obtained explicitly from information provided by a user and/or a request. A location may be obtained programmatically using a database, software application, stored information, information determined based on a user device, an entity indicated by a query, a selection by a user or a responder, etc. A user may be asked to clarify a location associated with a request. For example, if a named entity in a request is associated with more than one location, a user may be requested to identify a specific location. A default location of an entity may be provided based on location data associated with a user. A default location, or most recent location of a user may be determined to be a location associated with a request. Control is passed to operation 615 and process 600 continues

In operation 615 an automated answer is obtained. An automated response may be obtained programmatically using a database, software application, stored information, etc. A request may be submitted to a resource selected based on a request and/or a location determined for the request. An automated answer may be a stored answer selected based on a location. Control is passed to operation 620 and process 600 continues.

In operation 620, a determination is made as to whether an answer is available. If it is determined in operation 620 that an answer is not available, control is passed to operation 625 and process 600 continues. If it is determined in operation 620 that an answer is available, control is passed to operation 655 and process 600 continues.

The determination in operation 620 may be made based on various criteria. If a rating of an answer is below a predetermined threshold, it may be determined that an answer is not available. If an answer is not associated with a location associated with a request and the request is determined to be location sensitive, it may be determined that an answer is not available. If an answer is provided by a resource associated with a location, it may be determined that an answer is available. Availability of an answer may be determined for different types of answers. For example, if a sponsored answer which is associated with a location, an entity, a keyword, category, profile, etc. is available, it may be determined that an answer of that type is available. If an answer requires factual information and a request is determined to be temporal in nature and a stored answer is available it may be determined that an answer is not available. If a request is directed to subjective information and a previous answer by a responder associated with a location referenced by the request is available it may be determined that an answer is available. Any suitable criteria may be used to determine whether an answer is available. In at least one embodiment, it may be determined that an answer is available for one type of answer and that an answer is not available for another type of answer.

In operation 625, answerers are obtained. Answerers for a request may be obtained according to various criteria. Answerers may be obtained based on keywords associated with a request, a location, activity of answerers, a type of information requested, category of a request, etc. Answerers may be ranked based on any criteria associated with an answerer. In an embodiment a rank of an answerer may be based on proximity to a location, time of a response of an answerer, time of a request by an answerer, and a number of responses by an answerer associated with a topic, a location, and a user. Answerers may be determined based on presence information associated with an answerer. For example, if an answerer is logged into the system 100 (FIG. 1) an answerer may be rated or ranked higher than an answerer that is not logged in. Answerers may be selected based on a number of available answerers. For example if a selection of answerers would restrict to less than a predetermined number of answerers it may be required to adjust a selection criterion. Expertise of a responder may be weighted lower if a request is seeking subjective information. If a request is time sensitive, a current location of a responder may be weighted higher in selection of a responder. Control is passed to operation 630 and process 600 continues.

In operation 630, an answerer is notified. Any number of answerers may be notified in any order. A highest ranking answerer may be notified first. A number of answerers notified may be determined based on a type of information sought, a number of available answerers, etc. A number of answerers with a rating higher than a predetermined value may be notified. A number of answerers notified may have a minimum value. Control is passed to operation 635 and process 600 continues.

In operation 635, a determination is made as to whether a response is available. If it is determined in operation 635 that a response is available, control is passed to operation 645 and process 600 continues. If it is determined in operation 635 that a response is not available, control is passed to operation 640 and process 600 continues.

The determination in operation 635 may be made based on various criteria. If a result is provided by a number of answerers, it may be determined that a response is available. If a time period elapses after a request is received, it may be determined that a response is available. If a highest ranking responder is associated with a location farther than a pre-determined distance from a location associated with a request, it may be determined that a response is available. If a user affirms a response, it may be determined that a response is available.

In operation 640, a ranking is adjusted. A ranking of responders may be adjusted based on whether a responder has elected to accept a request. For example, if a responder has been notified of a request the responder may be ranked lower than responders that have not been notified of a request. If a responder sends a clarification request responsive to a notification, the responder may be ranked highest for a request. If a responder associated with a category, keyword, etc. responds to a notification, responders associated with the category, keyword, etc. may be ranked higher or lower. If a responder has become associated with a location since an initial ranking was performed, the responder may be added to a ranking. Control is passed to operation 625 and process 600 continued.

In operation 645, a response is provided. For example, a response of an answerer may be provided to the answer device 115 (FIG. 1). An answer may be provided based on an action of a responder. For example, a resource may provide information to a responder which may allow a responder to indicate a result. Control is passed to operation 650.

In operation 650, a determination is made as to whether a response is to be audited. If it is determined in operation 650 that a response is to be audited, control is passed to operation 655 and process 600 continues. If it is determined in operation 650 that a response is not to be audited, control is passed to operation 665 and process 600 continues.

In operation 655, an audit is performed. An audit may include an automated process wherein a stored result is verified based on media obtained from a resource associated with the answer. An audit may include checking and/or comparison of a stored result to a result obtained from a file returned by a resource associated with a stored answer including a review by a person. An audit may include a guide or responder performing a search for a query, which may be compared to a stored result. An audit may be performed after an answer has been provided. An audit may be performed in real-time. Control is passed to operation 660 and process 600 continues.

In operation 660, a determination is made as to whether an answer is acceptable. If in operation 660 it is determined that an answer is acceptable, control is passed to operation 665 and process 600 continues. If in operation 660 it is determined that an answer is not acceptable, control is passed to operation 610 and process 600 continues.

The determination in operation 660 may be made based on various criteria. A failure of an automated comparison, a rejection of a stored result by a guide, a mismatch of an answerer result with a stored result, etc. may be used to determine that an audit is not good. Likewise, a guide and/or an automated analysis may determine that an audit is good. If a time period for a real-time audit has elapsed, it may be determined that an audit is good. Any suitable criteria may be used to determine whether an audit is good.

In operation 665, a response is sent to a user. An answer may be delivered to a user via any communication service associated with the user. An answer may include any media which may be delivered using a communication service and a device of the user. For example, an SMS message, or IM might be delivered to a user mobile device. Control is passed to operation 670 and process 600 continues

In operation 670, process information is recorded. Information regarding any item such as a user, a guide, a responder, a request, a resource, an advertisement, a user, keyword, category, etc. may be recorded and/or updated. For example, a rating may be adjusted, a keyword, category, type, guide, sponsor, resource, time, user, answer, etc., of a request may be recorded. A rating and/or ranking of a resource may be updated and/or modified. A stored response may be rated, ranked, and/or deleted. In at least one embodiment, process information is recorded in the database 125 (FIG. 1). Control is passed to operation 605 and process 600 continues.

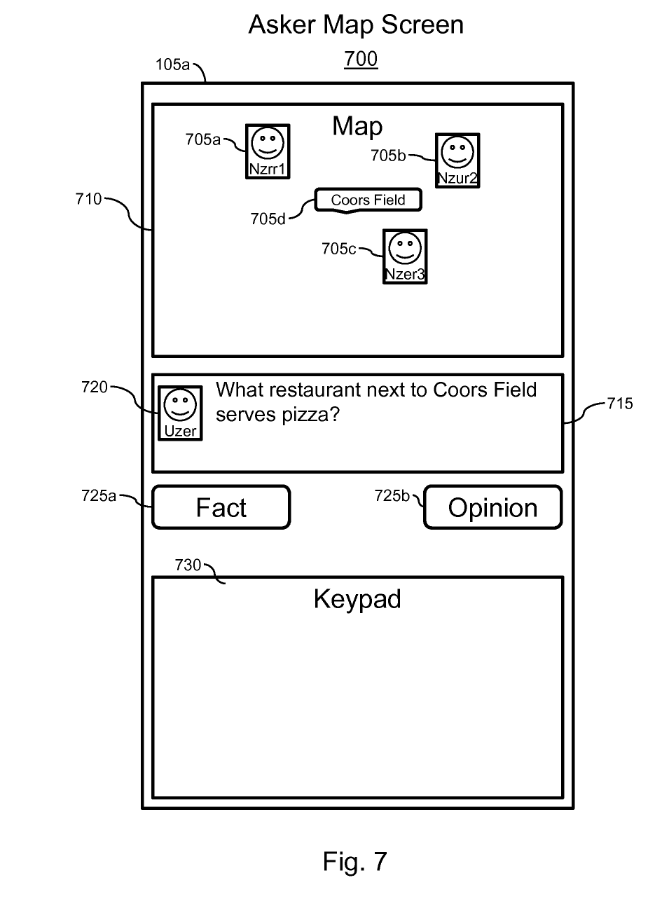

A GUI 700 for submitting a request associated with a location is illustrated in FIG. 7. The GUI 700 may include location indicators 705a-705d, a geographic display 710, a query indicator 715, a user indicator 720, query submission controls 725a, 725b and user controls 730. The GUI 700 may be presented by a device such as the user device 105a (FIG. 1).

The location indicators 705a-705d may be used to provide location information regarding a query indicated by the query indicator 715. For example, the location indicated by the named entity ‘Coors Field’ is indicated by the location indicator 705d. The location indicators 705a-705c may indicate a location associated with a responder. For example, a location associated with ‘Nzrr1’ is indicated by the location indicator 705a. Location indicators may be presented on a map which may include various features which may be relevant to a request. Location indicators may include temporal information, keywords, and/or other information of a responder associated with a location indicator. For example, information may be displayed by ‘hovering’ or otherwise activating a location indicator. A user may elect to direct a request to a responder and/or to exclude a responder by activating a location indicator associated with a responder. The geographic indicator 710 may be updated based on information indicated by the query indicator 715. The geographic indicator 710 may provide interactive selection of responders.

The query indicator 715 may be used to enter a query. Any type of information of a query may be indicated in the query indicator. The user indicator 720 may indicate information of a user submitting a request. The query submission controls 725a, 725b may be used to indicate a type of information sought by a request. For example, the ‘Opinion’ query submission control 725b may cause a request to be processed differently than the ‘Fact’ query submission control 725a. Likewise, a query submission control or feature may be provided which may allow a user to indicate that a query is temporally sensitive. The user controls 730 may enable a user to provide input to the user device 105a. Any type of input may be provided such as audio, images, touch, text, etc. using the user controls 730.

While the GUI 700 is illustrated using the example of a query which includes an explicit location, a query might be generated based on an implicit location. For example, if a query required location information, a user location might be inserted into a query and provided in the query indicator 715 and/or on the geographic display 710. A user might select responders associated with a named entity identified on the geographic display 710. A user might select responders who are currently located in a location indicated by the geographic display 710. A responder may not be identified explicitly but may be identified with an entity.

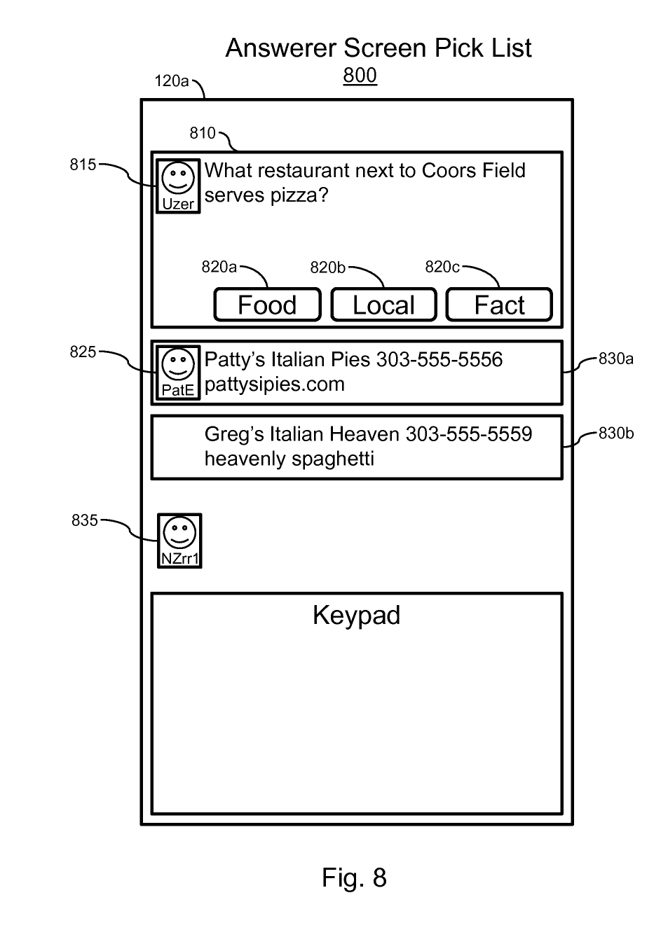

A GUI 800 for providing a response to a request is depicted in FIG. 8. The response GUI 800 may be provided using a device such as the answerer device 120a (FIG. 1). The GUI 800 may include a request indicator 810, a user indicator 815, query tagging indicators 820a-820c, a response source indicator 825, response indicators 830a, 830b, and a responder indicator 835.

The request indicator 810 may include information of a request associated with a location. The user indicator 815 may include information of a user associated with a request. The query tagging indicators 820a-820c may be used to indicate information associated with a request. The ‘Local’ query tagging indicator 820b may for example indicate that a query has been determined to be location sensitive. The response source indicator 825 may indicate information of a source of a response. For example, if an entity has provided a response in a database of queries and answers, the response source indicator may indicate the entity. If a response is obtained from an unbiased or ‘organic’ search, a response source indicator may not be associated with a response indicator as per the response indicator 830b. The responder indicator 830 may indicate information of a responder electing to respond to a request. A responder may submit a response to a request by activating a response indicator. For example, activation of the response indicator 830a may cause the associated response to be provided to ‘Uzer’ responsive to the request indicated in the request indicator 810.

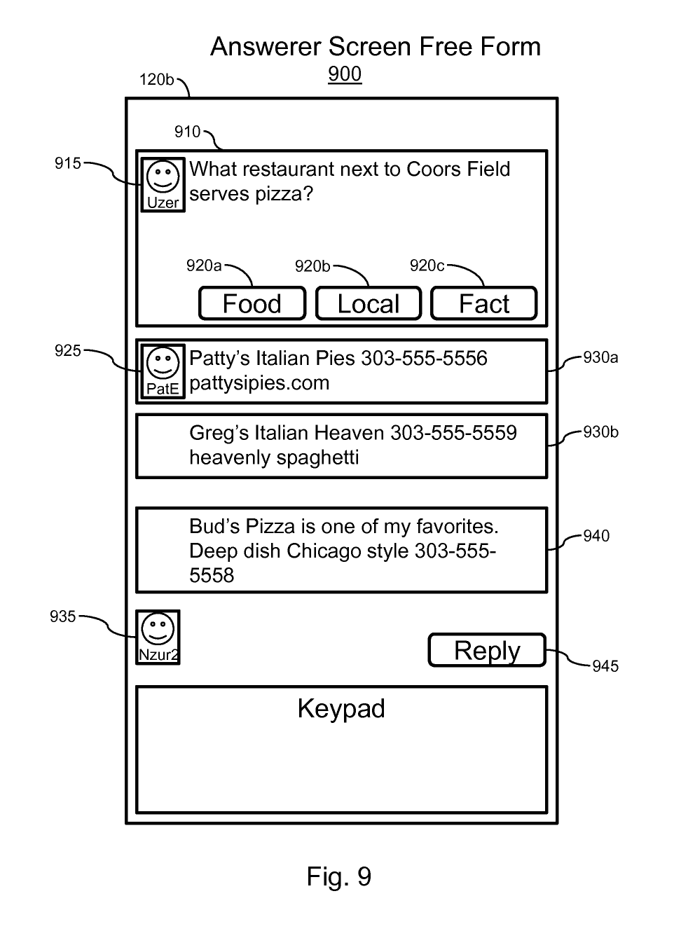

An alternate GUI 900 for providing a response to a request is depicted in FIG. 9. The free form response GUI 900 may be provided using a device such as the answerer device 120b (FIG. 1). The GUI 900 may include a request indicator 910, a user indicator 915, query tagging indicators 920a-920c, a response source indicator 925, response indicators 930a, 930b, a responder indicator 935, a free form response indicator 940, and an action control 945.

The functionality of the request indicator 910, the user indicator 915, the query tagging indicators 920a-920c, the response source indicator 925, and the response indicators 930a, 930b and the responder indicator 935 was previously explained with respect to FIG. 8. The free form response indicator 940 may be provided in order that a responder may provide a response which is different than the responses provided by the response indicators 930a, 930b. As illustrated, the responder ‘Nzur2’ has indicated an alternate response in the free form response indicator 940. The ‘Reply’ action control 945 may be used to submit a response indicated in the free form response indicator 940.

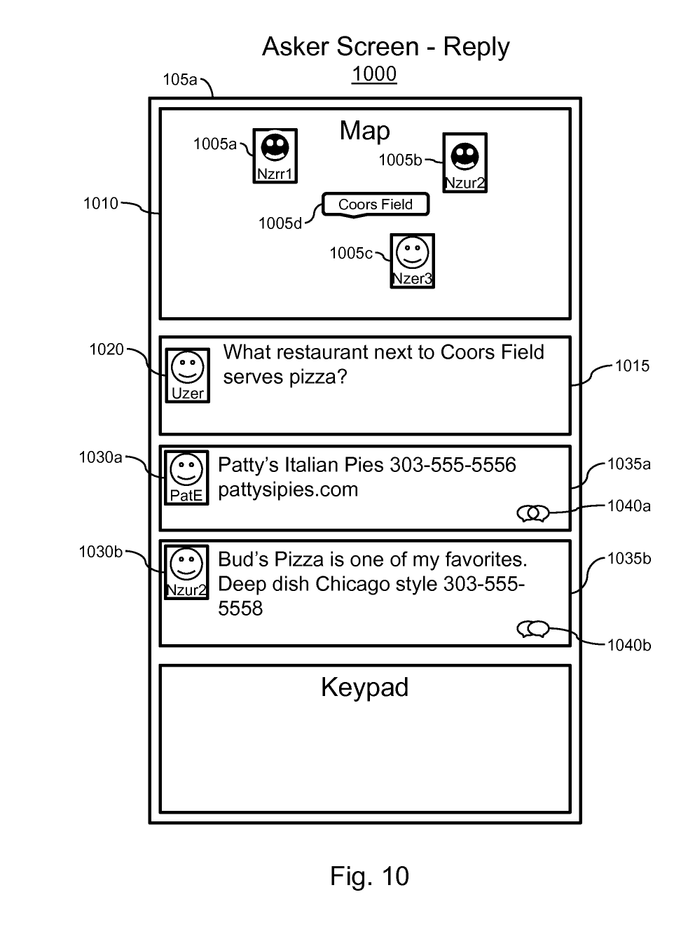

A GUI 1000 for receiving a response associated with a location is illustrated in FIG. 10. The GUI 1000 may include location indicators 1005a-1005d, a geographic display 1010, a query indicator 1015, a user indicator 1020, responder indicators 1030a, 1030b, response indicators 1035a, 1035b, and conversation controls 1040a 1040b. The GUI 1000 may be presented using a device such as the user device 105a (FIG. 1).

The location indicators 1005a-1005d may indicate location information associated with a response to a request indicated in the query indicator 1015 and/or a response indicated in the response indicators 1035a, 1035b. For example, the ‘filled’ faces in the location indicators 1005a and 1005b may indicate that a responder associated with those locations has responded, to a request, declined a request, etc. Any suitable indication such as color, underlining, etc. may be used to indicate status of a location indicator. The user indicator 1020 may indicate information of a user associated with a query indicated in the query indicator 1015. The responder indicators 1030a, 1030b may indicate information associated with a response. For example, the responder indicator 1030a indicates an entity as a source of an answer, while the response indicator 1030b indicates that ‘Nzur2’ has provided the answer indicated in the response indicator 1035b. The conversation indicators 1040a, 1040b may allow a user to establish a two-way and/or real-time communication with a responder associated with a response. For example, activation of the conversation indicator 1040a may permit a user to contact ‘PatE’ using information indicated in an entity record such as the entity record 500b (FIG. 5).

Using the methods and systems described herein a user may select a responder for a request based on a location. A location may be associated with a responder based on factors such as current location, historical locations associated with requests and/or responses, content of queries and/or responses, categories, keywords, and types of information which are associated with a responder. A ranking of a responder for a location may be based on a current location of a responder and/or a historical location of a responder. A responder may be selected based on a ranking of the responder for a subject matter of a request. A weighting of a location versus expertise in selection of a responder may be affected by factors such as a type of information sought, temporal information, etc.

A responder may be determined based on a map or geographic display provided to a user. A user may select a number of responders or answerers interactively based on location information associated with answerers, ratings and/or rankings of answerers for a topic, query, keyword, etc. A responder may be selected based on proximity to a location. A responder may observe an event and/or obtain information that is not published at the time the event occurs. A responder may be selected based on a location and an event determined by a user. For example, a responder may be selected when chronological criteria are met. For example, a user may request to get a report of traffic activity from a person in a particular location at a pre-determined time. Similarly, a responder might be selected based on an event source. For example, if a sports feed indicates that an event has completed, a responder may be requested or selected who is located in a parking facility, or at a restaurant located in proximity to a location.

A responder may be selected based on ratings and/or rankings of a responder for a request. A responder may reply with information based on an event observed by a responder. A responder may be provided with a toolset for responding to a request. A responder may be rated and/or ranked based on an entity associated with a request. A requester may establish a two-way communication with a responder and/or a source of a response based on a response to a request. A user may elect to be a responder. A responder may receive a request which is not originated by a user. A responder may receive a request based on an event and a location associated with the event and the responder.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A method of providing access to information, comprising:
receiving a request;
determining a location associated the request;
selecting a responder based on the location;
directing information of the request to the responder; and
obtaining a response of the responder.

2. The method of claim 1 further comprising:
determining the location based on content of the request; and
selecting the responder based on geographic information of an answer of the responder.

3. The method of claim 1 further comprising:
obtaining a demographic associated with the request; and
selecting the responder based on the demographic.

4. The method of claim 1 further comprising:
providing a stored response based on the location; and
directing the request to the responder when the responder meets a criterion associated with the location.

5. The method of claim 1 further comprising:
choosing an answerer based on content of the request;
excluding the location as a criterion of the choosing; and
directing the request to the answerer when an automated response is not available.

6. The method of claim 1 further comprising:
choosing a group of responders based on the location and a criterion; and
informing a source of the request that a responder is not available when a number of members of the group is below a pre-determined value.

7. The method of claim 1 further comprising:
selecting a group of responders based on the location;
determining whether the request is time sensitive; and
ranking the responders based on current geographic information of the responders when the request is time sensitive; and
directing the request to a highest ranking responder.

8. The method of claim 1 further comprising:
choosing a group of responders based on the location;
limiting the size of the group when the request is seeking factual information;
ranking the group based on a subject matter of the request; and
directing the request to a member of the group in an order based on the ranking.

9. The method of claim 1 further comprising:
selecting a group of responders based on the location;
ranking the group based on a subject matter of the request; and
directing the request to all members of the group when the request is seeking subjective information.

10. The method of claim 1 further comprising:
selecting the responder based on a geographic area designated by a source of the request responsive to an indication of locations of responders.

11. A system comprising:
a search service device receiving a request, determining a location associated with the request, selecting a responder based on the location, directing the request to the responder, and obtaining a response of the responder.

12. The system of claim 11 comprising:
a user device submitting the request; and
a responder device receiving information of requests and providing responses.

13. A non-transitory computer readable storage medium storing therein a program for causing a computer to execute an operation including providing access to information, comprising:
obtaining a request and a location associated the request;
selecting a responder based on the location;
directing information of the request to the responder; and
obtaining a response.

14. The computer readable storage medium of claim 13, the operation further comprising:
obtaining information of a group of responders based on the location;
presenting a graphic indicating the responders to a source of the request;
expanding the group based on an action received from the source.

15. The computer readable storage medium of claim 13, the operation further comprising:
selecting the responder based on a ranking of the responder for a subject matter of the request; and
adjusting the ranking based on a result of an audit of answers provided by the responder.

16. The computer readable storage medium of claim 13, the operation further comprising:
procuring a stored answer for the request; and
directing the information to the responder when the stored response comprises subjective information.

17. The computer readable storage medium of claim 16, the operation further comprising:
providing the stored answer to a source of the request;
obtaining the response from the responder; and
transmitting the response to the source of the request.

18. The computer readable storage medium of claim 13, the operation further comprising:
selecting the responder based on a subject matter of the request; and
directing the information to the responder based on a rank of the responder for the subject matter and the location.

19. The computer readable storage medium of claim 13, the operation further comprising:
assigning a geographic location to the responder based on historical information of requests submitted by the responder;
assigning geographic coordinates to the responder based on a location obtained from a user device;
selecting the responder based on the geographic location when the request is temporally insensitive; and
selecting the responder based on the geographic coordinates when the request is temporally sensitive.

20. The computer readable storage medium of claim 13, the operation further comprising:
selecting an answerer based on the location and a bid of the answerer associated with the location; and
directing information of the request to the answerer based on a subject matter of the request.
